(19) United States
(12) Patent Application Publication
(10) Pub. No.: US 2010/0126753 A1
(43) Pub. Date: May 27, 2010

(54) Communication cable

(75) Inventors: Fujio Seki, Shinagawa (JP); Yuichiro Terasawa, Shinagawa (JP)

Correspondence Address: STAAS & HALSEY LLP, SUITE 700, 1201 NEW YORK AVENUE, N.W., WASHINGTON, DC, 20005, US

(73) Assignee: FUJITSU COMPONENT LIMITED, Tokyo (JP)

(21) Appl. No.: 12/591,354

(22) Filed: Nov. 17, 2009

(30) Foreign Application Priority Data
Nov. 21, 2008 (JP) 2008-298831

(51) Int. Cl. H01B 11/06

(52) U.S. Cl. 174/102 R

(57) ABSTRACT

A communication cable connected between a first communication apparatus connected to an information processing apparatus and a second communication apparatus connected to a console, including: three pairs of signal lines that transmit a video signal from the information processing apparatus to the console via the first communication apparatus and the second communication apparatus; and a pair of signal lines that transmits an operation signal from the console to the information processing apparatus via the first communication apparatus and the second communication apparatus, and is shielded with a shield member.

### CROSS-REFERENCE TO RELATED APPLICATION

This application is based upon and claims the benefit of priority of the prior Japanese Patent Application No. 2008-298831, filed on Nov. 21, 2008, the entire contents of which are incorporated herein by reference.

### FIELD

A certain aspect of the embodiments discussed herein is related to a communication cable connected between a plurality of communication devices.

### BACKGROUND

Conventionally, there has been known a remote unit provided between a server and a console (a keyboard, a mouse, a monitor, or the like) in order to operate the server from the console which is away from the server by about 100 meters (see Japanese Laid-Open Patent Publication No. 2004-356939).

The remote unit is composed of a local device and a remote device, and a LAN (Local Area Network) cable is connected between the local device and the remote device. The server is connected to the local device, and the console is connected to the remote device.

In the remote unit, the remote device transmits an operation signal of the mouse or the keyboard to the local device, and receives an image signal from the local device. The local device receives the operation signal from the remote device, and transmits the image signal to the remote device. Therefore, when the operation signal and the image signal flow on the LAN cable at the same time, the image signal is disordered by the crosstalk (corresponding to a noise) of the operation signal, and there is the case where an image quality of the image signal decrease.

### SUMMARY

It is an object of the present invention to provide a communication cable that can control crosstalk of an operation signal to an image signal more than a conventional communication cable.

According to a first aspect of the present invention, there is provided a communication cable connected between a first communication apparatus connected to an information processing apparatus and a second communication apparatus connected to a console, including: three pairs of signal lines that transmit a video signal from the information processing apparatus to the console via the first communication apparatus and the second communication apparatus; and a pair of signal lines that transmits an operation signal from the console to the information processing apparatus via the first communication apparatus and the second communication apparatus, and is shielded with a shield member.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram showing the construction of a system including a remote unit;

FIG. 2 is a block diagram showing the schematic construction of the remote unit;

FIG. 3 is a diagram showing the specification of a LAN cable 3;

FIG. 4A is a diagram showing a first example of the schematic construction of the LAN cable 3, and FIG. 4B is a diagram showing the waveforms of an operation signal and an image signal (R) when the LAN cable 3 of FIG. 4A is used;

FIG. 5A is a diagram showing a second example of the schematic construction of the LAN cable 3, and FIG. 5B is a diagram showing the waveforms of the operation signal and the image signal (R) when the LAN cable 3 of FIG. 5A is used;

FIG. 6A is a diagram showing a third example of the schematic construction of the LAN cable 3, and FIG. 6B is a diagram showing the waveforms of the operation signal and the image signal (R) when the LAN cable 3 of FIG. 6A is used; and

FIG. 7 is a diagram showing the schematic construction of a Cat 7 (category 7) cable.

### DESCRIPTION OF EMBODIMENTS

A description will now be given, with reference to the accompanying drawings, of an embodiment of the present invention.

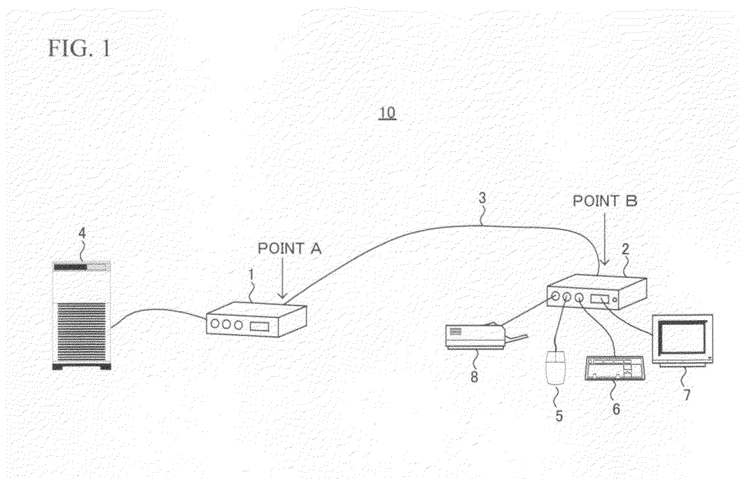

FIG. 1 is a diagram showing the construction of a system including a remote unit.

In FIG. 1, a system 10 includes a local device 1 (a first communication apparatus) and a remote device 2 (a second communication apparatus) which compose the remote unit, a server 4, a mouse 5, a keyboard 6, a monitor 7, and a printer 8. A LAN cable 3 is connected between the local device 1 and the remote device 2. The length of the LAN cable 3 is 300 meters. The server 4 is connected to the local device 1, and the mouse 5, the keyboard 6, the monitor 7, and the printer 8 are connected to the remote device 2. The mouse 5, the keyboard 6, the monitor 7, and the printer 8 function as a console.

The local device 1 receives an image signal, i.e., a video signal such as an RGB signal from the server 4, and transmits the image signal to the remote device 2 via the LAN cable 3. The local device 1 receives an operation signal of the mouse 5 or the keyboard 6 input to the remote device 2, via the LAN cable 3, and transmits the operation signal to the server 4. The remote device 2 receives the image signal from the local device 1 via the LAN cable 3, transmits the image signal to the monitor 7, and transmits the operation signal of the mouse 5 or the keyboard 6 to the local device 1 via the LAN cable 3. Thereby, the user can operate the server 4 from the mouse 5 and the keyboard 6.

In FIG. 1, a point A indicates a port (not shown) of the local device 1 to which the LAN cable 3 is connected. The point A is an observation point of a signal waveform of the operation signal received from remote device 2. A point B indicates a port (riot shown) of the remote device 2 to which the LAN cable 3 is connected. The point B is an observation point of a signal waveform of the image signal received from local device 1.

It should be noted that the mouse, the keyboard, and the monitor (not shown) can be also connected to the local device 1.

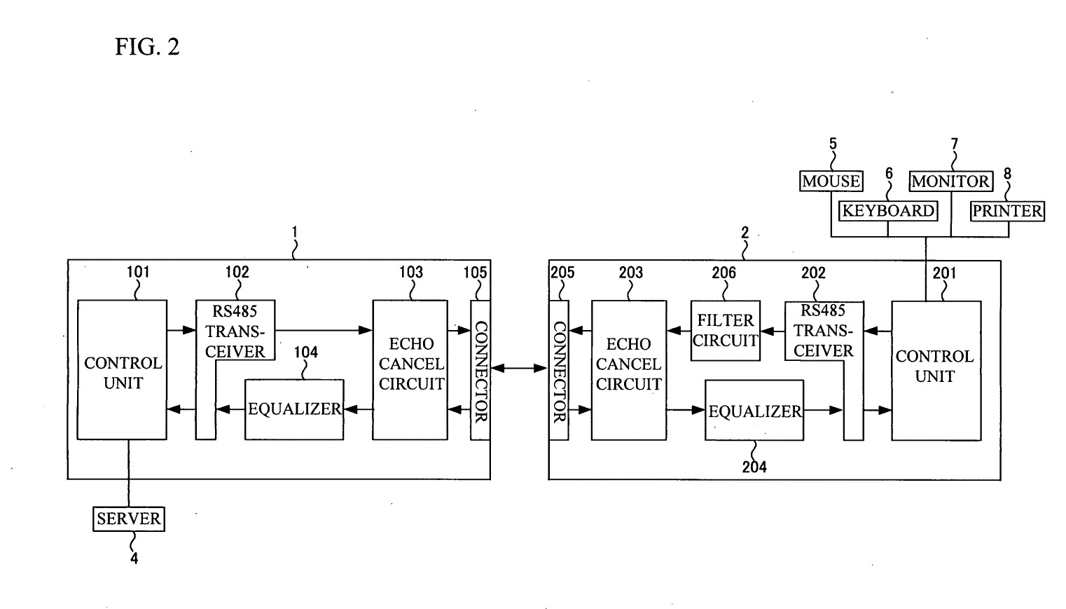

FIG. 2 is a block diagram showing the schematic construction of the remote unit.

The local device 1 includes a control unit 101, an RS485 transceiver 102, an echo cancel circuit 103, an equalizer 104 and a connector 105. The remote device 2 includes a control unit 201, an RS485 transceiver 202, an echo cancel circuit 203, an equalizer 204, a connector 205, and a filter circuit 206.

Each of the control units 101 and 201 is composed of a FPGA (Field

Programmable Gate Array; an LSI that can be operated by a program), and executes a control necessary for the transmission and reception of the image signal and the operation signal (e.g. switching an output destination of the image signal and the operation signal). The RS485 transceiver 102 outputs the operation signal received from the remote device 2 to the server 4, and transmits the image signal from the server 4 to the remote device 2. The RS485 transceiver 202 outputs the image signal received from the remote device 2 to the monitor 7, and transmits the operation signal from the mouse 5 or the keyboard 6 to the local device 1.

The echo cancel circuit 103 cancels an input by the reflection of the image signal transmitted to the remote device 2. The echo cancel circuit 203 cancels an input by the reflection of the operation signal transmitted to the local device 1.

The equalizer 104 amplifies the operation signal received from the remote device 2, and transmits the amplified operation signal to the control unit 101 via the RS485 transceiver 102. The equalizer 204 amplifies the image signal received from the local device 1, and transmits the amplified image signal to the control unit 201 via the RS485 transceiver 202. The amplified image signal is output to the monitor 7. The connector 105 connects the LAN cable 3 to the echo cancel circuit 103, and the connector 205 connects the LAN cable 3 to the echo cancel circuit 203.

To prevent the operation signal to be transmitted to the local device 1 from interfering in the image signal received from the local device 1, the filter circuit 206 reduces the velocity of rising and falling of the operation signal, i.e., makes an output waveform of the operation signal smooth. Thereby, the rising and the falling of the operation signal become smooth, to thereby avoid the generation of a noise in the image signal received from the local device 1.

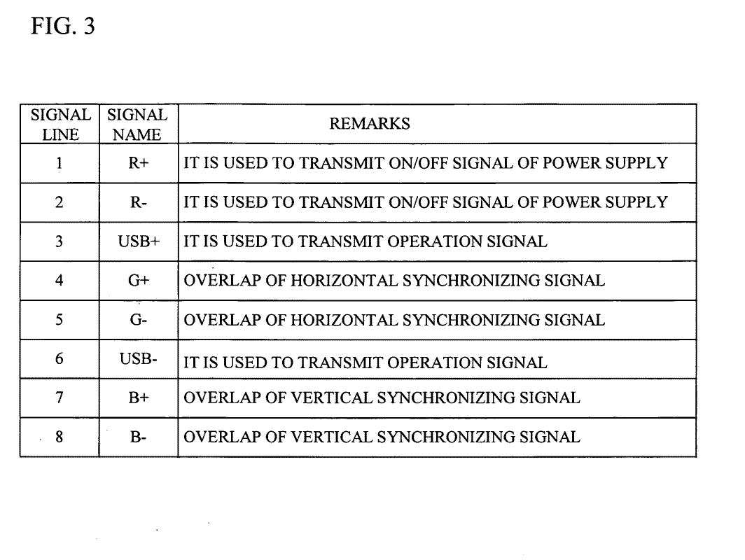

FIG. 3 is a diagram showing the specification of the LAN cable 3.

The LAN cable 3 is composed of, for example, a Cat 5 (category 5) cable, and includes eight signal lines. In the signal lines of numbers 1 and 2, a R-signal (R+ and R− in FIG. 3) as the differential signal is transmitted from the local device 1 to the remote device 2.

In the signal lines of numbers 4 and 5, a G-signal (G+ and G− in FIG. 3) as the differential signal is transmitted from the local device 1 to the remote device 2. In the signal lines of numbers 7 and 8, a B-signal (B+ and B− in FIG. 3) as the differential signal is transmitted from the local device 1 to the remote device 2. For example, in the local device 1, a horizontal synchronizing signal is overlapped with the G-signal, and a vertical synchronizing signal is overlapped with the B-signal. In the remote device 2, these overlapped signals are reinstated.

In the signal lines of numbers 3 and 6, the operation signal (USB1 and USB2 in FIG. 3) as the differential signal is transmitted from the remote device 2 to the local device 1.

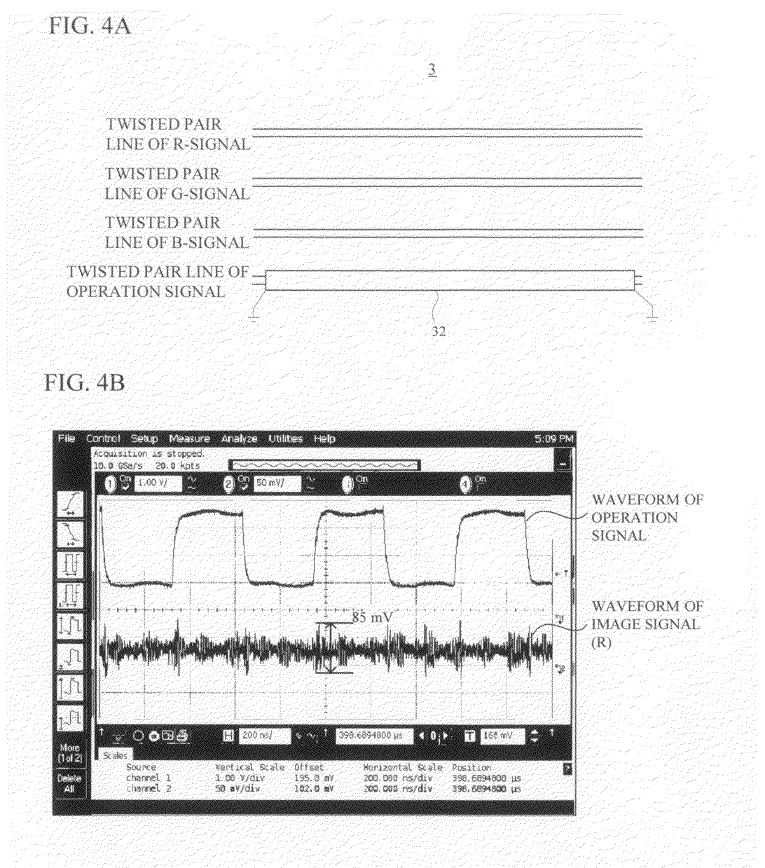

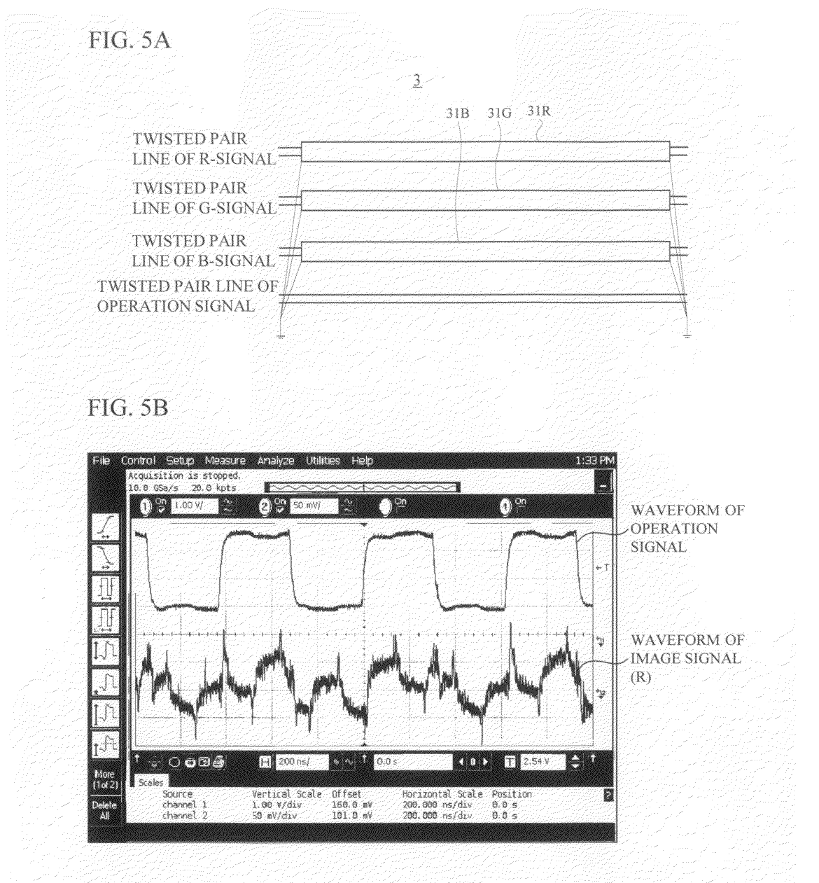

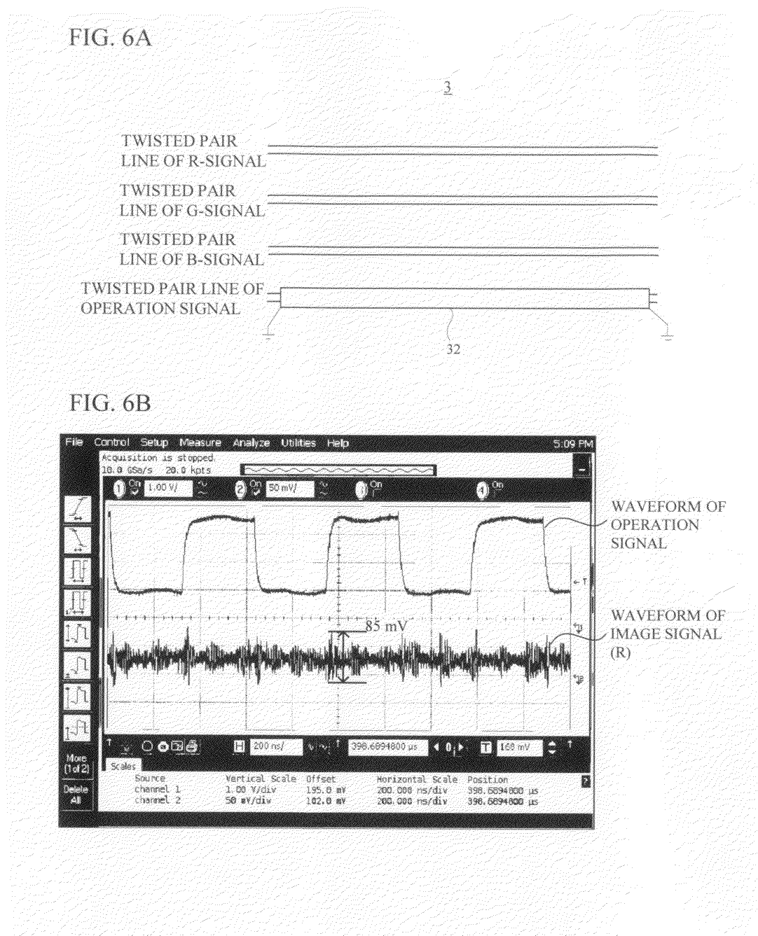

FIG. 4A is a diagram showing a first example of the schematic construction of the LAN cable 3, and FIG. 4B is a diagram showing the waveforms of the operation signal and the image signal (R) when the LAN cable 3 of FIG. 4A is used. FIG. 5A is a diagram showing a second example of the schematic construction of the LAN cable 3, and FIG. 5B is a diagram showing the waveforms of the operation signal and the image signal (R) when the LAN cable 3 of FIG. 5A is used. FIG. 6A is a diagram showing a third example of the schematic construction of the LAN cable 3, and FIG. 6B is a diagram showing the waveforms of the operation signal and the image signal (R) when the LAN cable 3 of FIG. 6A is used.

The present inventor has produced LAN cables of FIGS. 4A, 5A, and 6A, and has actually measured waveforms of the operation signal and the image signal (R) with each of the LAN cables (see FIGS. 4A, 5A, and 6A).

The LAN cable 3 is a LAN cable of 100 meters made by BELDEN company (model number 1700A). Twisted pair line included in the Cat 7 cable of a model number 1885ENH made by the BELDEN company has been used as a twisted pair line with a shield member. The waveforms of the operation signal and the image signal (R) have been measured with a remote unit (model number FE-1500CWV) made by FUJITSU COMPONENT LIMITED.

In FIG. 4A, the LAN cable 3 includes the twisted pair line for the R-signal (two signal lines), the twisted pair line for the G-signal (two signal lines), the twisted pair line for the B-signal (two signal lines), and the twisted pair line for the operation signal (two signal lines). All twisted pair lines are not shielded. Thereby, as shown in FIG. 4B, noises of about 150 mv have been generated in the image signal (R) by the crosstalk of the operation signal when the operation signal has risen and fallen, and hence the noises have affected the image quality of the image signal negatively.

In the LAN cable 3 of FIG. 5A, the twisted pair line for the R-signal, the twisted pair line for the B-signal, and the twisted pair line for the G-signal are shielded with shield members 31R, 31G, and 31B, respectively. The twisted pair line for the operation signal is not shielded. Both sides of each of the shield members 31R, 31G and 31B are grounded. In this case, as shown in FIG. 5B, the image signal (R) has become an unstable state, and the display of a normal image has become difficult.

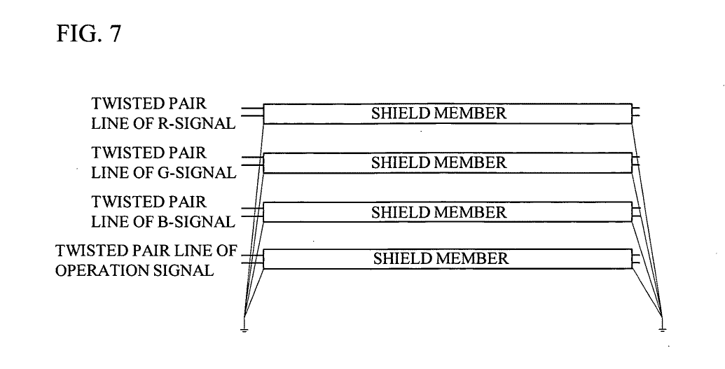

Even when the Cat 7 cable in which each of the twisted pair line for the R-signal, the twisted pair line for the G-signal, the twisted pair line for the B-signal, and the twisted pair line for the operation signal has been shielded as shown in FIG. 7 has been used, the waveforms of the operation signal and the image signal (R) has indicated a form as shown in FIG. 5B.

In the LAN cable of FIG. 6A, the twisted pair line for the operation signal is shielded with the shield member 32, and the twisted pair line for the R-signal, the twisted pair line for the G-signal, the twisted pair line for the B-signal are not shielded. Also, both ends of the shield member 32 are grounded. In this case, as shown in FIG. 6B, the noises generated in the image signal (R) have been able to be controlled to about 85 mv. The noises of about 85 mv represent the crosstalk mainly generated inside the local device 1. As a result, the image signal has been able to be displayed on the monitor 7 clearly.

As described in detail above, according to the present embodiment of the present invention, only the twisted pair line for the operation signal is shielded with the shield member 32. Thereby, it is possible to control the crosstalk of the operation signal to the image signal more than the conventional communication cable.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A communication cable connected between a first communication apparatus connected to an information processing apparatus and a second communication apparatus connected to a console, comprising:
three pairs of signal lines that transmit a video signal from the information processing apparatus to the console via the first communication apparatus and the second communication apparatus; and
a pair of signal lines that transmits an operation signal from the console to the information processing apparatus via the first communication apparatus and the second communication apparatus, and is shielded with a shield member.

2. The communication cable as claimed in claim 1, wherein both ends of the shield member are grounded.
